(19) United States
(12) Patent Application Publication
(10) Pub. No.: US 2026/0203241 A1
(43) Pub. Date: Jul. 16, 2026

(54) SYSTEM AND METHOD OF AUTOMATICALLY PRIORITIZING AUDIO FORMATS FOR TRANSMISSION FROM AN INFORMATION HANDLING SYSTEM TO A DIGITAL DISPLAY DEVICE SUPPORTING PLURAL AUDIO FORMATS

(71) Applicant: Dell Products LP, Round Rock, TX (US)

(72) Inventors: Bee June Tye, Singapore (SG); Lei Guo, Singapore (SG); Wai Yuen Ho, Singapore (SG)

(73) Assignee: Dell Products LP, Round Rock, TX (US)

(21) Appl. No.: 19/024,162

(22) Filed: Jan. 16, 2025

(51) Int. Cl. G06F 13/42

(52) U.S. Cl. CPC G06F 13/4221; G06F 2213/0042

(57) ABSTRACT

A digital display device comprising a display device controller to execute machine readable code instructions of a universal serial bus (USB) audio device prioritizing agent to detect that a current audio profile setting is configured for automatic audio data format selection, and to transmit to an operatively coupled information handling system, via a USB Type-C connector, an initial extended display identification data that identifies the digital display device as compatible with a USB audio data format standard if the display device controller detects that a USB path is active on a USB dedicated pin or to identify the digital display device as compatible with a DisplayPort® (DP) audio data format standard if no USB path is detected, and the digital display device to automatically receive an audio data signal on shared pins of the USB Type-C connector from the information handling system in the identified audio data format standard.

### FIELD OF THE DISCLOSURE

The present disclosure generally relates to digital display devices that operatively couple with information handling systems via Universal Serial Bus (USB) Type-C connectors that allow for the transmission of audio in multiple audio formats, including audio data with video data or audio data alone over available USB pins. The present disclosure more specifically relates to executing machine readable code instructions of a system and method for automatically prioritizing transmission of audio signals between an information handling system and a digital display device to auto-select between the USB audio class 1(UAC1 ) format or other formats, such as DisplayPort (DP) alternate audio used over a USB Type-C connector.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication and network communication capabilities. Further, the information handling system may include video and audio capabilities with an operably coupled digital display device, such as an external standalone digital display device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an device prioritizing controller of an information handling system executing machine readable code instructions of a Universal Serial Bus (USB) audio device prioritizing system and working in tandem with a USB Audio Device Prioritizing agent at an operably coupled digital display device to automatically select an audio format for output of audio data on a USB Type-C connector to the digital display device according to an embodiment of the present disclosure;

FIG. 2 is a block diagram illustrating a digital display device with a USB Audio Device Prioritizing agent to automatically select between a USB audio data format and a DisplayPort (DP) audio formats supported at the digital display device for input of audio data via a USB Type-C connector from an operably coupled information handling system according to an embodiment of the present disclosure;

FIG. 3 is a block diagram illustrating an information handling system executing a USB Audio Device Prioritizing system to automatically select a DP alternate audio format over a USB Audio Class 1 (UAC1) audio format for output of audio data via a USB Type-C connection to an operably coupled digital display device according to an embodiment of the present disclosure;

FIG. 4 is a block diagram illustrating an information handling system executing a USB Audio Device Prioritizing system to automatically select a UAC1 audio format over the DP alternate audio format for output of audio data to an operably coupled digital display device over a USB Type-C connection according to an embodiment of the present disclosure; and

FIG. 5 is a flow diagram illustrating a method of executing machine readable code instructions to automatically select between the UAC1 and DP alternate audio formats supported at a digital display device for output of audio data from an information handling system to the operably coupled digital display device on a USB Type-C connection according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

External digital display devices, such as external monitors for computers, are increasingly being operably coupled to information handling systems via Universal Serial Bus (USB) Type-C ports and connectors. The USB Type-C standard requires dedication of four pins within the USB Type-C connector at one end of a USB Type-C connection and a corresponding group of four pin receptacles within the USB Type-C port for transmission and receipt of video and audio signals between the devices operably coupled to one another via mating of the USB Type-C ports and the USB Type-C connectors of a USB Type-C cable. The current USB Type-C standard supports transmission and receipt of audio signals according to multiple audio formats or video formats via these same four pins which may be shared pins. For embodiments of the present disclosure, with each audio format requires encoding and decoding using separate audio codecs within the digital display device operably coupled to the information handling system via the USB Type-C cable connection. For example, the USB Type-C connection most recently developed supports transmission and receipt of audio signals according to the USB Audio Class 1(UAC1 ) format standard, as well as according to a DisplayPort® (DP) alternate audio format standard. Such audio data may be transmitted and received alone or in connection with transmission and receipt of video data across the USB Type-C connection according to embodiments of the present disclosure, where the audio data may be played back on speakers or received from a microphone on-board the external digital display device in embodiments herein.

When a digital display device that supports receiving audio signals via both of these audio format standards is operably coupled to an information handling system via such a multi-format USB Type-C connection having shared pins, the information handling system may automatically identify the digital display device as two separate devices, namely one device for each audio format hub within and supported by the operably coupled digital display device. For example, a USB hub within the digital display device may be auto-detected as a USB audio device and a DP hub, such as operating with a scaler hardware controller within the digital display device, may be auto-detected as a DP audio device. When this happens, the information handling system may prompt the user of the information handling system and the digital display device to select which of these detected devices, or audio format hubs, to which the audio data transmitted from the information handling system should be output. In other words, the information handling system may prompt the user to select whether to output audio to a USB device (e.g., the digital display device acting as a USB audio output device via a USB hub) in the UAC1 format or to output audio to a DisplayPort® (DP) device (e.g., the digital display device acting as a DP device via a DP hub at a scaler hardware controller rather than a USB device). These prompts may be confusing and annoying to the user of the information handling system especially since the user may perceive only one device connected, namely the single external digital display device. A system in embodiments of the present disclosure is described to automatically choose between output of audio data according to the UAC1 format or according to the DP alternate audio format in detected circumstances where one standard is more beneficial than the other to avoid the user having to choose. The system of embodiments of the present disclosure may still provide for selection between audio formats by the user in circumstances where the user may identify an audio profile setting for one or more audio modes indicating a preference for additional user control over selection of one audio format over another for differing types of audio applications.

An audio signal device prioritizing controller of the information handling system executing machine readable code instructions of a USB Audio Device Prioritizing system may work in tandem with a display device hardware controller, such as a codec controller, of an operably coupled digital display device executing machine readable code instructions of a USB Audio Device Prioritizing agent in embodiments of the present disclosure to address these issues by automatically selecting between the UAC1 or DP alternate audio format for output of audio to the digital display device when certain circumstances or audio profile settings are detected. Each of the available audio formats supported by the USB Type-C standard and the operably coupled digital display device to the information handling system provide different benefits over one another. For example, the DP alternate audio standard was developed to provide higher quality or higher fidelity audio than the existing USB audio standard, which may be preferable to a user that is watching a movie, listening to music, or playing a computer game in which high fidelity is valued. However, the UAC1 audio format supports echo cancellation and bi-directional audio which may be beneficial to a user participating in a videoconference in which many participants may be talking over one another or simultaneously. In still other situations, some digital display devices or USB Type-C cables may only be capable of supporting one of these audio formats.

The display device hardware controller may be a codec controller, scaler hardware controller or other hardware processing resource on the digital display device to execute machine readable code instructions of the USB Audio Device Prioritizing agent in embodiments herein. Execution of the USB Audio Device Prioritizing agent detects which of these audio formats are supported by the digital display device, as well as a current audio profile setting indicating the way in which the user is using the digital display device and whether additional audio control is desired over the digital display device. Depending on the current audio profile setting of the digital display device, the USB Audio Device Prioritizing agent automatically prompts the information handling system to activate shared pins of the USB Type-C connector thereon to transmit audio according to an audio format that is most beneficial for the detected operating circumstances. In an example embodiment, the display device hardware controller may execute machine readable code instructions of the USB Audio Device Prioritizing agent to detect whether a USB data path is active on a USB dedicated pin, to a USB controller on the information handling system, to determine whether the UAC1 audio standard or the DP audio standards should be used on the least two shared pins of the USB Type-C connection port or connectors. When a USB path is active on the USB pins for transmitting and receiving USB data, then the UAC1 audio format standard may be selected, indicating that the user is currently using the digital display device as a USB audio device. In another example embodiment, when the display device hardware controller may execute machine readable code instructions of the USB Audio Device Prioritizing agent detects that a USB path is not active on the USB pins for transmitting and receiving USB data, then the DP audio format standard may be selected, indicating that the user is currently using the digital display device as a DP audio device.

Once an audio format has been automatically selected by the display device hardware controller executing machine readable code instructions of the USB Audio Device Prioritizing agent, or selected by the user pursuant to advanced user audio control due to a selected audio profile setting, notification is sent to an audio signal device prioritizing controller at the information handling system executing machine readable code instructions of a USB Audio Device Prioritizing system. The audio signal device prioritizing controller at the information handling system may send a control comment to configure or maintain a reconfigurable multiplexer (MUX) at the information handling system USB Type-C port. The audio signal device prioritizing controller at the information handling system may configure the reconfigurable MUX to operably couple the hardware component at the information handling system that supports the automatically selected or user-selected audio format to the shared pins of the USB Type-C port. For example, the audio signal device prioritizing controller of the information handling system executing machine readable code instructions of the USB Audio Device Prioritizing system may operably connect a USB controller that supports the selected UAC1 format to shared pins on the USB Type-C port of the information handling system via the reconfigurable MUX. As another example, the audio signal device prioritizing controller of the information handling system executing machine readable code instructions of the USB Audio Device Prioritizing system may operably connect a graphics processing unit GPU that supports the selected DP alternate audio format to shared pins of the USB Type-C port of the information handling system via the reconfigurable MUX. In such a way, the audio signal device prioritizing controller of the information handling system executing machine readable code instructions of a USB Audio Device Prioritizing system may work in tandem with a display device hardware controller of an operably coupled digital display device executing machine readable code instructions of a USB Audio Device Prioritizing agent in embodiments of the present disclosure to automatically select between the UAC1 audio format and the DP alternate audio format for output of audio data on shared pins to the digital display device, depending on a detected usage profile setting describing the way in which the user is currently using the digital display device.

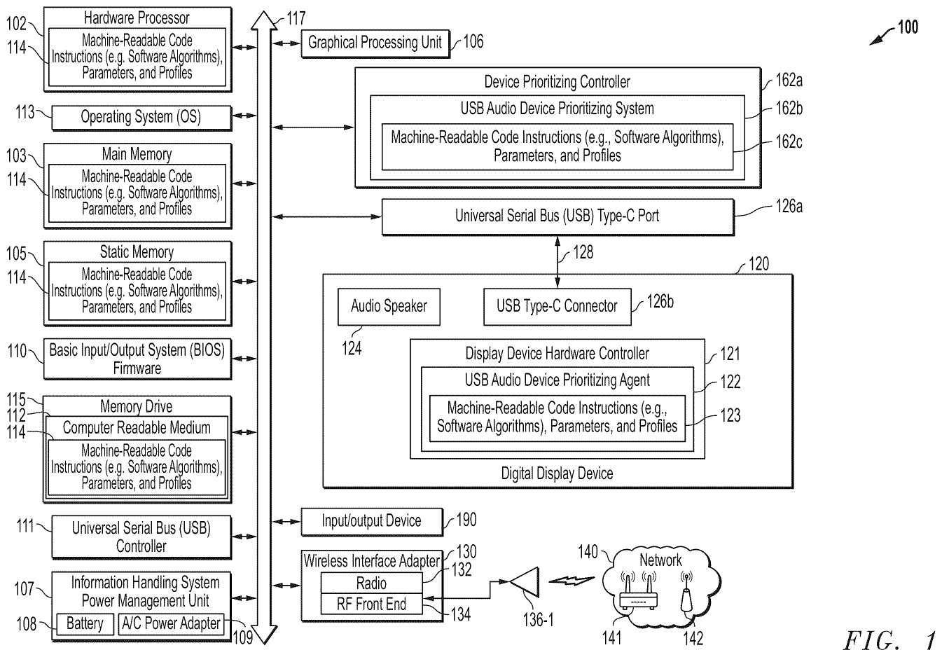

Turning now to the figures, FIG. 1 illustrates an information handling system 100 similar to the information handling systems according to several aspects of the present disclosure. As described herein, an external digital display device 120, such as an external monitor for a computer, may be operably coupled to an information handling system 100 via a Universal Serial Bus (USB) Type-C connection 128 that may be a USB Type-C cable and USB Type-C port 126a at information handling system and USB Type-C connector 126b on the digital display device 120. The USB Type-C standard requires dedication of four pins within the USB Type-C connector 126a and a corresponding group of four pins or receptacles within the USB Type-C port 126b for transmission and receipt of video and audio signals between the digital display device 120 operably coupled to the information handling system 100 via mating of the USB Type-C connector 126b to the USB Type-C port 126a via a cable. The current USB Type-C standard supports transmission and receipt of audio data signals according to multiple audio formats as well as plural video data formats for video data via these same four pins, or shared pins in the USB Type-C connection 128 connectors and cabling. For example, two shared pins of the USB Type-C port 126a and connector 126b may be used for plural audio data formats with each audio format requiring encoding and decoding using separate audio codecs within the digital display device 120 and different hardware components formatting the audio data at the operably coupled information handling system 100. For example, the USB Type-C connection 128 most recently developed supports transmission and receipt of audio signals according to the USB Audio Class 1(UAC1 ) standard as well as according to the DisplayPort® (DP) alternate audio standard on a set of shared pins in embodiments herein. Further, the USB Type-C connection 128 includes pins dedicated for USB connection, such as USB 2.0 data connection pins, which may be sensed for an active pin signal (e.g., a high or low status signal) to determine if a USB data path on the USB dedicated pins to the USB controller 111 at the information handling system is active. This may be used to automatically select between the UAC1 audio data format or the DP alternate audio data format on the shared pins in embodiments of the present disclosure.

When a digital display device 120 that supports receiving audio signals via both the UAC1 audio format and the DP alternate audio format is operably coupled to an information handling system 100 via a multi-format USB Type-C connection 128, the information handling system 100 may auto-identify the digital display device 120 as two separate audio devices to a user without execution of embodiments of the present disclosure. In an embodiment, the two identified audio devices that are auto-identified from the digital display device may be one device attributed for each audio format due to the two available audio device hubs and codec capabilities that exist on the digital display device 120. The USB hub at the digital display device 120 may be detected and auto-identified as a USB audio device while, at the same time, the DP hub, such as the scaler hardware controller supporting DP audio and video, may be detected and auto-identified as a DP audio device at the digital display device 120 as well. The information handling system 100 then prompts the user to select which of these two detected devices of the digital display device 120 to which the audio should be output. In other words, the information handling system 100 may prompt the user to select whether to output audio to a USB device (e.g., the digital display device 120 having a USB hub acting as a USB audio output device) in the UAC1 format or to output audio to a DisplayPort® device (e.g., the digital display device 120 having a DP hub that may be the scaler hardware controller acting as a DP device rather than a USB device). This option for selection may be fine for advanced audio control if so desired by a user, but other user's may find this prompting for selection from two audio devices for the same digital display device 120 confusing or annoying.

An audio signal device prioritizing controller 162a of an information handling system 100 executing machine readable code instructions 162c of a USB Audio Device Prioritizing system 162b and working in tandem with a display device hardware controller 121, which may be an audio codec hardware controller, of an operably coupled digital display device 120 executing machine readable code instructions 123 of a USB Audio Device Prioritizing agent 122 may automatically select among the plural audio formats in lieu of presenting a selection requirement to a user in some embodiments herein. For example, USB Audio Device Prioritizing agent 122 at the digital display device 120 may receive identification of supported audio formats and a default or user-selected audio mode for the digital display device as an audio profile setting for the digital display device in embodiments herein. Depending on the audio profile setting detected as active on the digital display device 120, the USB Audio Device Prioritizing agent 122 executing at the digital display device 120 will automatically select between the UAC1 audio format or the DP alternate audio format or may present the user with the option to select among the USB audio device or the DP audio device on the digital display device 120. Execution of the USB Audio Device Prioritizing agent 122 at the digital display device 120 for automatic selection of between the supported audio data formats for output of audio data to the digital display device 120 with smart audio device selection, and playback via the digital display device speaker 124, may occur when a “standard” or “voice” mode is selected by the user, such as with a default audio profile setting indicating little interest in advanced audio control by a user. Other more specific audio modes or selection of a custom audio mode as an audio profile setting, may indicate a desire for more advanced user audio control and presentation of both supported audio data format options to the user.

Execution of the USB Audio Device Prioritizing agent 122 at the digital display device 120 for automatic selection of between the supported audio data formats for output of audio data to the digital display device 120 with smart audio device selection, and playback via the digital display device speaker 124 may be determined by detection of active data path at other USB dedicated pins in the USB Type-C connection 128 at the USB Type-C connector 126b on the digital display device 120. For example, the USB Audio Device Prioritizing agent 122 executed by the digital display device controller 121 at the digital display device 120 may detect USB 2.0 pins are active with a high indicator at the USB Type-C connector 126b on those pins in an embodiment.

If the USB dedicated pins indicate an active data path to the USB controller 111 at the information handling system 100, the USB Audio Device Prioritizing agent 122 determines that a USB controller 111 is active at the information handling system 100 and selects the UAC1 audio data format by activating the USB hub at the digital display device. The digital display device controller 121 may notify the USB Audio Device Prioritizing system 162b at the information handling system 100 of the determination of the UAC1 format and the digital display device 120 being designated as a USB audio device to ensure operative coupling of the shared pins of the USB Type-C port 126a to the USB controller 111 that supports the UAC1 audio data format via a reconfigurable multiplexer (MUX).

If the USB dedicated pins indicate no active data path to the USB controller 111 at the information handling system 100, the USB Audio Device Prioritizing agent 122 determines that the USB controller 111 is not active and selects the DP alternate audio data format by activating the DP hub of the scaler hardware controller at the digital display device 120. The digital display device controller 121 may notify the USB Audio Device Prioritizing system 162b at the information handling system 100 of the determination of the DP alternative audio data format and the digital display device 120 being designated as a DP audio device to ensure operative coupling of the shared pins of the USB Type-C port 126a to the graphics processing unit (GPU) 106 that supports the DP alternate audio data format via a reconfigurable multiplexer (MUX).

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 115. The information handling system 100 may include or interface with one or more communications ports for communicating with external devices, as well as an input/output (IO) device 190, a video/graphics digital display device 120, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 or 162c that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 or 162c may operate on a plurality of information handling systems 100.

The information handling system 100 may include the hardware processor 102 such as a central processing unit (CPU) or other hardware processing resources. Any of the hardware processing resources may operate to execute machine readable code instructions 114 or 162c that are either firmware or software code. Moreover, the information handling system 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 or 162c executable by the hardware processor 102, EC 104, GPU 106, or any other hardware processing device. The information handling system 100 may also include one or more buses 117 operable to transmit communications between the various hardware components such as any combination of various I/O devices 190, as well as between hardware processors 102, an EC 104, GPU 106 or other, the operating system (OS) 113, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 190 described herein. As described herein, the information handling system 100 further includes a video/graphics digital display device 120. The video/graphics digital display device 120 in an embodiment may function as a liquid crystal display (LCD), an organic light emitting diode (OLED), a flat panel display, or a solid-state display. It is appreciated that the video/graphics digital display device 120 may be wired or wireless and, in embodiments of the present disclosure, may be an external video/graphics digital display device 120 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114, or 162c or receives and executes instructions, parameters, and profiles 114, or 162c responsive to a propagated signal, so that a hardware device connected to a network 140 may communicate voice, video, or data over the network 140. Further, the machine readable code instructions 114, or 162c may be transmitted or received over the network 140 via the network interface device or wireless interface adapter 130.

The information handling system 100 may include a set of machine readable code instructions 114, or 162c that may be executed to cause the computer system to perform any one or more of the methods or computer-based functions disclosed herein. For example, machine readable code instructions 114, or 162c may be executed by a hardware processor 102, GPU 106, EC 104, or device prioritizing controller 162a or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows®, Androi®, and other OS types. Example APIs may include Win 32, Core Java API, or Android APIs.

In an embodiment, the information handling system 100 may include a disk drive unit 115. The disk drive unit 115 and may include machine-readable code instructions, parameters, and profiles 114, or 162c in which one or more sets of machine-readable code instructions, parameters, and profiles 114, or 162c such as firmware or software can be embedded to be executed by the hardware processor 102 or other hardware processing devices such as a GPU 106 or EC 104, device prioritizing controller 162a or other hardware controller device to perform the processes described herein. Similarly, main memory 103 and static memory 105 may also contain a computer-readable medium for storage of one or more sets of machine-readable code instructions, parameters, or profiles 114, or 162c described herein. The disk drive unit 115 or static memory 105 also contain space for data storage. Further, the machine-readable code instructions, parameters, and profiles 114, or 162c may embody one or more of the methods as described herein. In a particular embodiment, the machine-readable code instructions, parameters, and profiles 114, or 162c may reside completely, or at least partially, within the main memory 103, the static memory 105, and/or within the disk drive 115 during execution by the hardware processor 102, EC 104, GPU 106, or device prioritizing controller 162a of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114, or 162c such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 115, the hardware processor 102 (e.g., CPU), the EC 104, the GPU 106, the device prioritizing controller 162a, a video/graphic digital display device 120, or other wired I/O devices 190 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

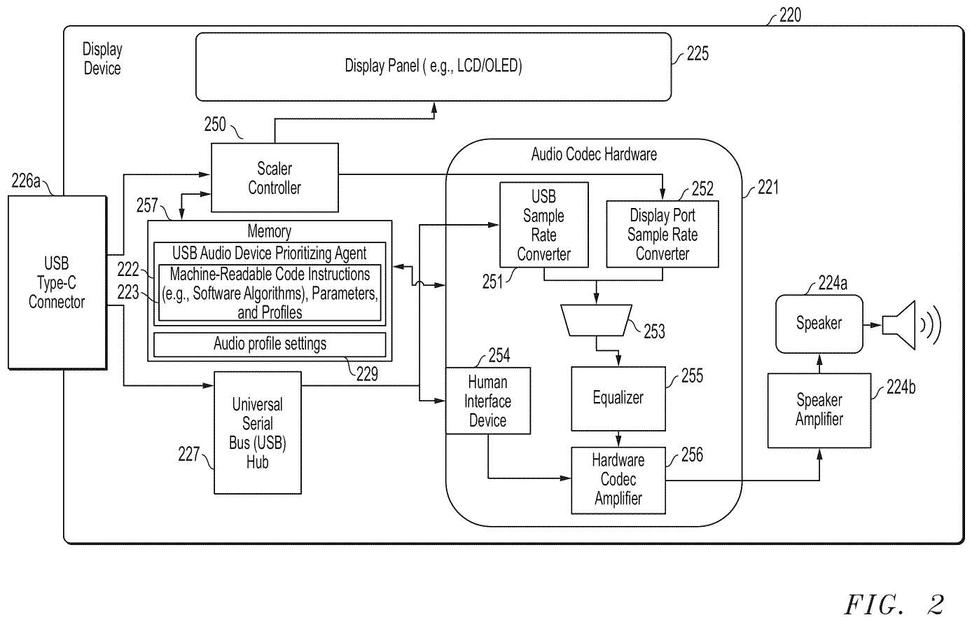

FIG. 2 is a block diagram illustrating a display device hardware controller of a digital display device executing machine readable code instructions of a Universal Serial Bus (USB) audio device prioritizing agent to automatically select between audio data formats for receiving input of audio data from an operably coupled information handling system in certain circumstances according to an embodiment of the present disclosure. As described herein, when a digital display device 220 supports receiving audio data signals via both the USB Audio Class 1 (UAC1) audio data format or DisplayPort (DP) alternate audio data format is operably coupled to an information handling system via a multi-format USB Type-C connector 126a, the information handling system may auto-identify the digital display device 220 as two separate devices, namely one audio device for each audio format supported. For example, the USB hub 227 is detected as supporting the UAC1 audio data format and is identified as a USB audio device and the scaler controller operating a DP audio hub is identified as a DP audio device. This auto-identification then prompts the user of the information handling system to select which of these detected USB and DP audio devices at the information handling system to which the audio should be output. A display device hardware controller, such as codec hardware controller 221 or scaler hardware controller 250 of the digital display device 220 executing machine readable code instructions 223 of a USB Audio Device Prioritizing agent 222 and working in tandem with an audio signal device prioritizing controller at an information handling system executing machine readable code instructions of a USB Audio Device Prioritizing system (not shown) may automatically select between the UAC1 audio format and DP alternate audio format for receipt of audio data at the digital display device 220 when certain audio profile settings 229, such as a standard mode or voice mode, are in effect by default or user selection. In other circumstances, the user may be presented with a audio format selection graphical user interface (GIU) screen at the display panel 225 when other audio profile settings 229, such as a movie, gaming, music, or custom mode, are in effect and advanced user audio control may be desired by a user.

Each of the available audio formats supported by the USB Type-C standard provide different benefits over one another. For example, the DP alternate audio standard was developed to provide higher quality or higher fidelity audio than the existing USB audio standard, which may be preferable to a user that is watching a movie, listening to music, or playing a computer game in which high fidelity is valued. However, the UAC1 audio format supports echo cancellation which may be beneficial to a user participating in a videoconference in which many participants may be talking over one another or simultaneously. In still other situations, some digital display devices or USB Type-C cables may only be capable of supporting one of these audio formats.

The display device hardware controller, for purposes of explanation of example embodiments herein refers to a audio codec hardware controller 221, in an embodiments herein for executing machine readable code instructions 223, such as firmware, of the USB Audio Device Prioritizing agent 222 to detect which of these audio formats are supported by the digital display device 220, to detect a current audio profile setting 229 indicating the way in which the user is using the digital display device 220, and to determine if a USB path is active on the USB pins of a connected USB Type-C connector 226a back to a USB controller at the operatively coupled information handling system. In other embodiments, it is contemplated that the scaler controller 250 or another hardware controller on the digital display device 220 may execute the code instructions 223 of the USB Audio Device Prioritizing agent 222, but for purposes of discussion the display device hardware controller 221 refers to the audio codec hardware controller 221. Depending on the detected audio profile setting 229 in effect, the display device hardware controller 221 may detect whether the USB path is active on USB dedicated pins of the USB Type-C connector 226a to automatically prompt the information handling system operably coupled via the USB Type-C connector 226a to transmit audio on shared pins of the USB Type-C connection according to an audio format determined based on whether the USB controller is active at the information handling system.

For example, the display device hardware controller 221 may execute machine readable code instructions 223 of the USB Audio Device Prioritizing agent 222 to detect that the USB Type-C pins within the USB Type-C connector 226a, such as USB 2.0 data pins, have an active path for transmitting and receiving data with the USB controller at the information handling system based on a high or active setting on those USB dedicated pins. This may indicate that the user is currently using the digital display device 220 as a USB audio output device, that the information handling system is actively operating with USB, or that the USB Type-C cord, port, or connector 226a does not support the DP alternate audio standard, as may be the case with older components. As another example, the display device hardware controller 221 may execute machine readable code instructions 223 of the USB Audio Device Prioritizing agent 222 to detect that the USB Type-C pins within the USB Type-C connector 226a does not have an active path for transmitting and receiving data with the USB controller based on a low or inactive setting on those USB dedicated pins. This may indicate that the digital display device 220 is currently operating as a DisplayPort® (DP) audio and video device or that the information handling system is actively operating with the DP standard including the DP alternate audio data format in some example embodiments. In such scenarios above, the display device hardware controller 221 may execute machine readable code instructions 223 of the USB Audio Device Prioritizing agent 222 to automatically select and identify itself to the information handling system either as a USB audio device when the USB path is active or select and identify itself as a DP audio device when the USB path is inactive using an extended display identifier (EDID) transmitted from the digital display device 220 to the information handling system via the USB Type-C connector 226a.

When automatic selection of the audio data format from among plural supported audio data formats is conducted, the display device hardware controller 221 may execute machine readable code instructions 223 of the USB Audio Device Prioritizing agent 222 to set the USB hub or the scaler hardware controller 250 operating as a DP hub to receive audio data for that particular audio data format. The audio data may be automatically received on the shared pins of the USB Type-C connector 226a according to the UAC1 audio data format standard, in an example embodiment, to the USB hub 227 when the digital display device notifies the operably coupled information handling system it is operating as a USB audio device via the EDID data in one embodiment. The audio data may be automatically received on the shared pins of the USB Type-C connector 226a according to the DP alternate audio data format standard, in an example embodiment, to the scaler controller 250 operating as a DP hub when the digital display device notifies the operably coupled information handling system it is operating as a DP audio device via the EDID data in another embodiment.

For example, in the case where the digital display device 220 is currently set to standard or voice audio profile 229, this may indicate that the user is participating in a videoconference or, at the least, is not interested using the digital display device 220 to have advanced user audio control to view video with high audio fidelity, such as a movie or game. In such a case, it may be beneficial to the user to have the audio data format automatically selected, such as to receive audio in the UAC1 audio format at the USB hub 227 that supports echo cancellation, in order to provide a better user experience during a videoconference by decreasing outside noises when the USB controller is active. The display device hardware controller 221 may execute machine readable code instructions 223 of the USB Audio Device Prioritizing agent 222 in such a scenario to automatically select for receipt of audio data on the shared pins using the UAC1 standard at the USB controller 227 and identify itself to the information handling system as a USB audio device using an EDID transmitted from the digital display device 220 to the information handling system, via the USB Type-C connector 226a. Similarly, for viewing video with high audio fidelity, it may be beneficial to automatically select to receive audio data in the DP alternate audio data format at the scaler hardware controller 250. The display device hardware controller 221 may execute machine readable code instructions 223 of the USB Audio Device Prioritizing agent 222 in such a second scenario to automatically select for receipt of audio data on the shared pins using the DP alternate audio standard at the scaler controller 250 and identify itself to the information handling system as a DP audio device using an EDID transmitted from the digital display device 220 to the information handling system, via the USB Type-C connector 226a. This may automatically select for the best audio format for the current usage of the digital display device 220 without prompting the user to make such a selection.

In other embodiments, when an audio profile setting 229 is set to require additional advanced user audio control, such as for a movie, gaming, music or custom audio mode, the display device hardware controller 221 may execute machine readable code instructions 223 of the USB Audio Device Prioritizing agent 222 may not execute to automatically select between the supported audio data formats. As described herein, this may cause the information handling system to automatically recognize the digital display device 220 as two separate device and prompt the user to choose which device to which audio should be output. In such a scenario, the display device hardware controller 221 may execute machine readable code instructions 223 of the USB Audio Device Prioritizing agent 222 to implement the user selected audio format that is best suited for the user, and then to identify itself to the information handling system as an external audio device of the audio data format selected by the user.

In an example, in the case where the digital display device 220 is currently set to movie, music, or gaming audio profile 229, this may indicate that the user is using the digital display device 220 to view video with high audio fidelity in which the higher quality DP alternate audio format may be beneficial. In such a case, the display device hardware controller 221 may execute machine readable code instructions 223 of the USB Audio Device Prioritizing agent 222 to transmit single EDID identifying both audio formats to identify the digital display device 220 as supporting both audio formats, and allowing the user to choose a preference. The display device hardware controller 221 may execute machine readable code instructions 223 of the USB Audio Device Prioritizing agent 222 in such a scenario to prompt the user to make a selection between the UAC1 format and the DP alternate audio format according to embodiments herein before receiving audio data on the shared pins of the USB Type-C connector 226a.

The digital display device 220 may receive an audio data signal in the automatically selected or manually selected audio data format from the information handling system, via the USB Type-C connector 226a, and process that audio signal via an appropriate audio codec for that audio format. For example, if the digital display device 220 receives audio in the UAC1 format on shared pins of the USB Type-C, the display hardware controller 221 may execute machine readable code instructions 223 of the USB Audio Device Prioritizing agent 222 to activate the USB hub 227 and route the incoming UAC1 signal to the USB hub 227. The USB hub 227 may then transfer the UAC1 data to a USB sample rate converter 251 or human interface device module (HID) 254 within the audio codec hardware controller 221 for decoding using an algorithm specific to the UAC1 audio format or other USB data format. As another example, if the digital display device 220 receives audio data in the automatically selected or manually selected DP alternate audio format, the digital hardware controller 221 may execute machine readable code instructions 223 of the USB Audio Device Prioritizing agent 222 to activate the scaler controller 250 and route the incoming DP alternate audio data format signal to the scaler hardware controller 250. The scaler hardware controller 250 may forward an audio component of received data on the shared pins of the USB Type-C connector 226a to a DP sample rate converter 252 within the audio codec hardware controller 221 for decoding using an algorithm specific to the DP alternate audio format. In either of these scenarios, the decoded audio data signal may then be processed through a multiplexer 253, an equalizer 255, a hardware codec amplifier 256, and a speaker amplifier 224b for output via the speaker 224a of the digital display device 220.

The digital display device 220 may include memory 257, which may be volatile (e.g., random-access memory, etc.), or nonvolatile (read-only memory, flash memory etc.) or any combination thereof), one or more hardware processing resources, such as the digital display device hardware controller which may be any of the audio codec hardware controller 221, a scalar hardware controller 250, other hardware controllers, or any combination thereof. The digital display device 220 may include or interface with one or more communications ports or USB Type-C connector 226a for communicating with external devices, such as an operably coupled information handling system.

The digital display device 220 may include devices or modules that embody one or more of the hardware devices or hardware processing resources executing machine readable code instructions for one or more systems and modules. The digital display device 220 may execute machine readable code instructions (e.g., software or firmware algorithms), parameters, and profiles 223 according to various embodiments herein. The digital display device 220 may include the display device hardware controller 221 (e.g., the audio codec hardware controller 221 or the scaler hardware controller 250), or other hardware processing resources. Any of the hardware processing resources may operate to execute machine readable code instructions 223 that are either firmware or software code. Moreover, the digital display device 220 may include memory 257 with computer readable medium storing machine readable code instructions (e.g., software or firmware algorithms), parameters, and profiles 223 executable by the display device hardware controller 221 or any other hardware processing device.

The digital display device 220 may include a set of instructions 223 that may be executed to cause the computer system to perform any one or more of the methods or computer-based functions disclosed herein. For example, machine readable code instructions 223 may be executed by the display device hardware controller 221 or any other hardware processing resource and may include software agents, or other aspects or components used to execute the methods and systems described herein. Further, the machine-readable code instructions, parameters, and profiles 223 may embody one or more of the methods as described herein. In a particular embodiment, the machine-readable code instructions, parameters, and profiles 223 may reside completely, or at least partially, within the memory 257 during execution by the display device hardware controller 221.

Memory 257 or other memory of the embodiments described herein may contain computer-readable medium (not shown), such as RAM in an example embodiment. An example of memory 257 includes random access memory (RAM) such as static RAM (SRAM), dynamic RAM (DRAM), non-volatile RAM (NV-RAM), or the like, read only memory (ROM), another type of memory, or a combination thereof. In another example, memory 257 may contain computer-readable medium (not shown), such as NOR or NAND flash memory in some example embodiments.

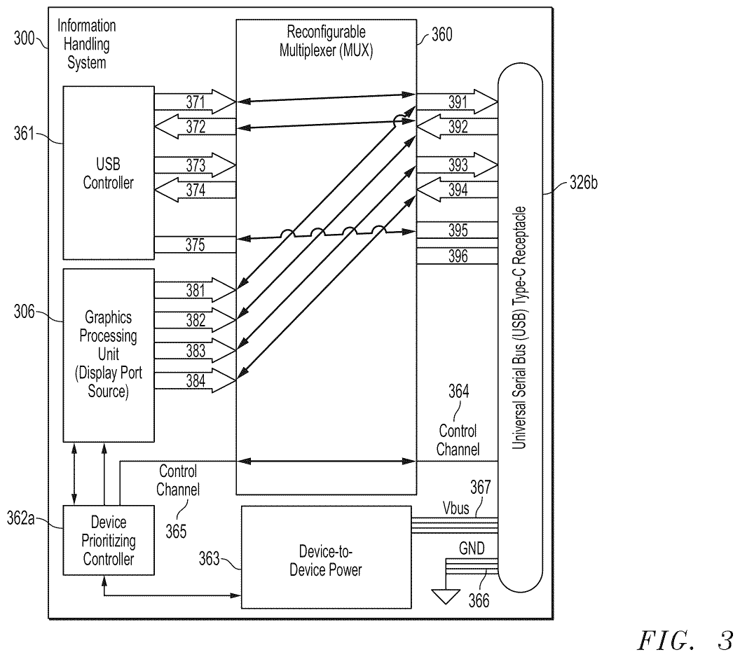

FIG. 3 is a block diagram illustrating an audio signal device prioritizing hardware controller of an information handling system executing machine readable code instructions of a Universal Serial Bus (USB) audio device prioritizing system to automatically select a DisplayPort (DP) alternate audio format among plural supported audio data formats for output of audio data on shared pins of a USB Type-C port receptacle to an operatively coupled digital display device in certain circumstances according to an embodiment of the present disclosure. The audio signal device prioritizing hardware controller of an information handling system 300 executing machine readable code instructions of the USB Audio Device Prioritizing system works in tandem with a display device hardware controller of an operably coupled digital display device (not shown in FIG. 3) to automatically select, or allow user selection of, the DisplayPort (DP) alternate audio format from a DP source, such as graphics processing unit (GPU) 306, from among plural supported audio data formats for output of audio data to the digital display device when certain audio profile settings are in effect according to an embodiment of the present disclosure. As described herein, an external digital display device, such as digital display device 220 of FIG. 2 may be operably coupled to information handling system 300 via Universal Serial Bus (USB) Type-C port 326b (e.g., via connection at the USB Type-C connector 226a of FIG. 2). The USB Type-C standard requires dedication of four shared pins (a positive pin and a negative pin within each pin set) within the USB Type-C connector (e.g., 226a of FIG. 2) and a corresponding group of four shared pin receptacles 391, 392, 393, and 394 (a positive pin and a negative pin within each pin receptacle set) within the USB Type-C port 326b for transmission and receipt of audio data signals as well as video data signals between the information handling system 300 and digital display device 220 of FIG. 2. Two of those shared pins operably coupled to one another via mating of the USB Type-C port 326b to the USB Type-C connector (226a of FIG. 2) may be used, at least in part, for transmission of audio data signals in either of two supported audio data formats for a DP alternate audio data or UAC1 audio data format.

The current USB Type-C standard supports transmission and receipt of audio signals according to plural audio formats via these shared pins, with each audio format requiring encoding and decoding using separate audio codecs within the digital display device operably coupled to the information handling system 300 via the USB Type-C port 326b. Differing hardware components within the information handling system 300 may generate the audio data, as well as video data, in the plural supported audio data formats. For example, the USB Type-C connection most recently developed supports transmission and receipt of audio signals according to the USB Audio Class 1(UAC1 ) standard, as well as according to the DisplayPort® (DP) alternate audio standard. In embodiments herein, the UAC1 audio data, as well as video data, may be generated by operation of a USB controller 361. In other embodiments, the DP alternate audio data, as well as DP video data, may be generated by operation of GPU 306 as a DP source. In some embodiments, GPU 306 may also operate as a source of USB data. More specifically, however, the shared pin receptacle sets 393 and 394 of the USB Type-C port 326b in an embodiment may be capable of transmission via 394 and reception via 393 of audio data signals from various internal hardware components of the information handling system 300, including the USB controller 361 or the GPU 306, according to either the UAC1 or DP alternate audio formats respectively. The pin receptacle sets 391 and 392 in an embodiment may be dedicated to transmission via 392 and reception via 391 of video signals from the graphics processing unit (GPU) 306. Pin receptacle sets 391 and 392 in an embodiment may also be capable of communication of high-speed USB data signals, such as video or other data, (e.g., separate from USB audio signals) with the USB controller 361. Reconfigurable multiplexer (MUX) 360 may be switchable and operably coupled the shared pin sets 393 and 394, as well as 391 and 392, with hardware components GPU 306 or USB controller 361 in embodiments herein.

The pin receptacle 395 may be USB dedicated pins on the USB Type-C receptacle 326b and operably coupled to the USB controller 361 via pin 375 for the transmission of USB data. Similarly, pin receptacle 396 may be a USB dedicated pin on the USB Type-C port receptacle 326b in embodiments herein. For example, USB dedicated pin 395, as well as USB pin 396, may transmit or receive USB data via a data path with USB controller 361 under the USB 2.0 standard supported by USB compatible external devices that preceded the USB Type-C standard. When a USB data path is active to the USB controller 361 in embodiments herein, such as under the USB 2.0 standard for example and via the pin receptacle 395 and pin 375 or via pin receptacle 396, this may indicate that the USB controller 361 is active with the capability to output USB audio in the UAC1 format and an external device operably coupled to the USB Type-C port 326b is currently to operate as a USB specific device. When USB data path is not detected as active to the USB controller 361 via the pin receptacle 395, or pin 396 in embodiments herein, this may indicate that the external device operably coupled to the USB Type-C port 326b is currently not to operate as a USB specific device and instead the GPU 306 may operate it as a DP specific device. The status of pin receptacle 395 may be detectable via a high or active signal by the USB controller 361 when an active USB data path is available or a low signal with the pin receptacle 395 off to the USB controller 361 indicating no active USB data path in embodiments herein.

The USB Type-C standard also supports the supply of power via the operable connection of the USB Type-C port 326b to the USB Type-C connector (226a of FIG. 2). Upon such a connection, the device prioritizing hardware controller 362a may direct the device to device power module 363 to transmit power through the voltage bus 367 to the USB Type-C port 326b with a ground 366.

When a digital display device that supports audio data formats for both the UAC1 audio format and the DP alternate audio format is operably coupled to an information handling system 300 via a multi-format USB Type-C connection, the information handling system 300 may auto-identify the digital display device as two separate devices for each audio data format as described in embodiments herein. As described in embodiments herein, an automatic selection of the audio data format may be made based on the status of the USB pin receptacle 395 or 396 for the USB controller 361 or the user may be prompted by the information handling system 300 to select which of these detected devices and audio data formats with which the audio data should be output. In other words, the digital display device may automatically select and identify itself as the automatically selected audio device of a particular audio data format in some embodiments when an audio profile setting is detected such that advanced user audio control is not required. In other embodiments, the user may select whether to output audio in a UAC1 audio data format with the digital display device identifying itself as a USB audio device or to output audio in a DP alternate audio format with the digital display device identifying itself as a DisplayPort® audio device (e.g., the digital display device acting as a DP audio device rather than a USB audio device).

An audio signal device prioritizing controller 362a of an information handling system 300 executing machine readable code instructions of a USB Audio Device Prioritizing system and working in tandem with a display device hardware controller of an operably coupled digital display device executing machine readable code instructions of a USB Audio Device Prioritizing agent may receive notification of the automatically-select audio data format or the user-selected audio data format and configure the reconfigurable MUX 360 via a control channel 365. The audio signal device prioritizing controller 362a may switch or maintain operable coupling between the shared receptacle pins 393 and 394 (as well as 391 and 392 in some embodiments) with the corresponding USB controller 361 or GPU 306 via the reconfigurable MUX 360 using the control channel 365 depending on the received notification from the digital display device via an EDID notification in embodiments herein. Control channel 364 may also be used to determine orientation of the USB Type-C connection within the USB Type-C port receptacle 326b for determining orientation of pins connected in some embodiments. GPU 306 may be operably coupled with the reconfigurable MUX 360 via pins 381, 382, 383, and 384 in an embodiments and may be connected to shared receptacle pins 391, 392, 393, and 394 respectively through switching (or maintaining) connection via the reconfigurable MUX 360. USB controller 361 may be operably coupled with the reconfigurable MUX 360 via pins 371, 372, 373, and 374 in an embodiments and may be connected to shared receptacle pins 391, 392, 393, and 394 respectively through switching (or maintaining) connection via the reconfigurable MUX 360. USB controller 361 may also include pin 375 connected through reconfigurable MUX 360 to USB dedicated receptacle pin 395 or 396 of the USB Type-C port receptacle 326b according to embodiments herein. In the shown embodiment, where the audio signal device prioritizing controller 362a of an information handling system 300 executing machine readable code instructions of a USB Audio Device Prioritizing system is notified that a DP audio device has been automatically or user-selected, the reconfigurable MUX 360 configures to operably couple the GPU 306 via pins 381, 382, 383, and 384 to shared receptacle pins 391, 392, 393, and 394, with shared receptacle pins 393 and 394 for DP alternate audio formatted audio data from GPU 306. Further, in the selection of the DP audio device as the digital display device, the reconfigurable MUX 360 configures to operably couple the USB controller 361 via pins 371 and 372 to shared receptacle pins 391 and 392 for video or other highspeed USB data from the USB controller 361.

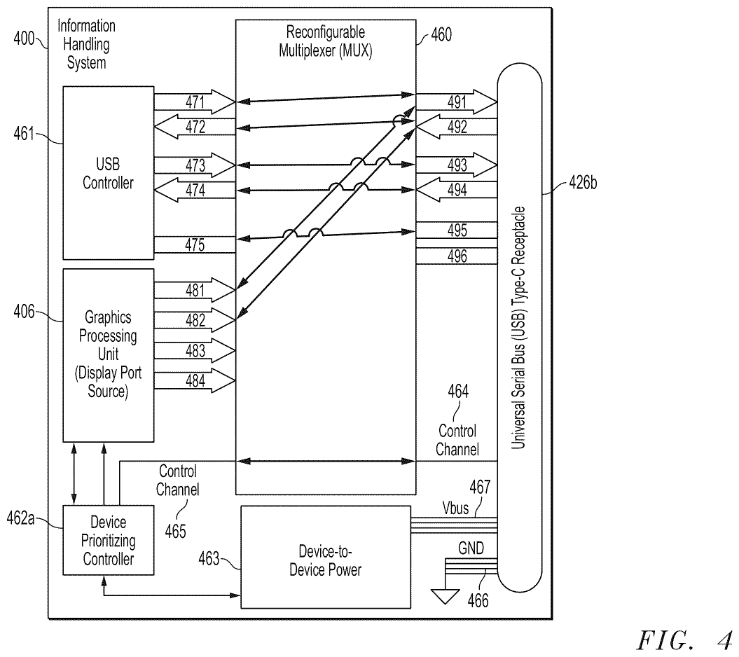

FIG. 4 a block diagram illustrating an audio signal device prioritizing hardware controller of an information handling system executing machine readable code instructions of a Universal Serial Bus (USB) audio device prioritizing system to automatically select a USB audio class 1(UAC1 ) audio format among plural supported audio data formats for output of audio data on shared pins of a USB Type-C port receptacle to an operatively coupled digital display device in certain circumstances according to an embodiment of the present disclosure. The audio signal device prioritizing controller 462a on the information handling system 400 executes machine readable code instructions of a Universal Serial Bus (USB) audio device prioritizing system and works in tandem with a display device hardware controller of an operably coupled digital display device (not shown in FIG. 4) to automatically select, or allow user selection of, the UAC1 audio format from the USB controller 361 for output of audio data to the digital display device from among plural supported audio data formats for output of audio data to the digital display device when certain audio profile settings are in effect according to an embodiment of the present disclosure. As described herein, an external digital display device, such as digital display device 220 of FIG. 2 may be operably coupled to information handling system 400 via Universal Serial Bus (USB) Type-C port 426b (e.g., via connection at the USB Type-C connector 226a of FIG. 2). The USB Type-C standard requires dedication of four shared pins (a positive pin and a negative pin within each pin set) within the USB Type-C connector (e.g., 226a of FIG. 2) and a corresponding group of four shared pin receptacles 491, 492, 493, and 494 (a positive pin and a negative pin within each pin receptacle set) within the USB Type-C port 426b for transmission and receipt of audio data signals as well as video data signals between the information handling system 400 and digital display device 220 of FIG. 2. Two of those shared pins operably coupled to one another via mating of the USB Type-C port 426b to the USB Type-C connector (226a of FIG. 2) may be used, at least in part, for transmission of audio data signals in either of two supported audio data formats for a DP alternate audio data or UAC1 audio data format.

As described above, the USB Type-C standard supports transmission and receipt of audio signals according to plural audio formats via these shared pins, with each audio format requiring encoding and decoding using separate audio codecs within the digital display device and operably coupled via the USB Type-C port receptacle 426b. Differing hardware components within the information handling system 400 may generate the audio data, as well as video data, in the plural supported audio data formats. For example, the transmission and receipt of audio signals according to the USB Audio Class 1 (UAC1) standard, as well as video data or other USB data may be generated via the USB controller 461 while the DisplayPort® (DP) alternate audio standard data, as well as video data, may be generated with the GPU 406 as a DisplayPort® source. More specifically, however, the shared pin receptacle sets 493 and 494 of the USB Type-C port 426b in an embodiment may be capable of transmission via 494 and reception via 493 of audio data signals from various internal hardware components of the information handling system 400, including the USB controller 461 or the GPU 406, according to either the UAC1 or DP alternate audio formats respectively. The pin receptacle sets 491 and 492 in an embodiment may be dedicated to transmission and reception of video data signals from the graphics processing unit (GPU) 406 in an embodiment. Pin receptacle sets 491 and 492 in another embodiment may also be capable of communication of high-speed USB data signals, such as video or other data, (e.g., separate from USB audio signals) with the USB controller 461. Reconfigurable multiplexer (MUX) 460 may operably couple and switchable between the shared pin sets 493 and 494, as well as 491 and 492, and the hardware components GPU 406 or USB controller 461 in embodiments herein.

The pin receptacle 495 may be a USB dedicated pin on the USB Type-C receptacle 326b and operably coupled to the USB controller 461 via pin 475 for the transmission of USB data. Similarly, pin receptacle 496 may be a USB dedicated pin on the USB Type-C port receptacle 426b in embodiments herein. For example, USB dedicated pin 495, as well as USB pin 496, may transmit or receive USB data via a data path with USB controller 461 under the USB 2.0 standard supported by USB compatible external devices that preceded the USB Type-C standard. When a USB data path is active to the USB controller 461 in embodiments herein, such as under the USB 2.0 standard for example, via the pin receptacle 495 and pin 475 or via pin receptacle 496, this may indicate that the USB controller 461 is active with the capability to output USB audio in the UAC1 format and external device operably coupled to the USB Type-C port 426b is currently to operate as a USB specific device. When USB data path is not detected as active to the USB controller 461 via the receptacle pin 495, or receptacle pin 496 in embodiments herein, this may indicate that the external device operably coupled to the USB Type-C port 426b is currently not to operate as a USB specific device and instead the GPU 406 may operate it as a DP specific device. The status of pin receptacle 495 may be detectable via a high or active signal from the USB controller 461 when an active USB data path is available or a low signal with the pin receptacle 495 off to the USB controller 461 indicating no active USB data path in embodiments herein.

The USB Type-C standard also supports the supply of power via the operable connection of the USB Type-C port 426b to the USB Type-C connector (226a of FIG. 2). Upon such a connection, the device prioritizing hardware controller 462a may direct the device to device power module 463 to transmit power through the voltage bus 467 to the USB Type-C port 426b with a ground 466 providing a ground line for the USB Type-C port 426b connection.

When a digital display device that supports audio data formats for both the UAC1 audio format and the DP alternate audio format is operably coupled to an information handling system 400 via a multi-format USB Type-C connection, the information handling system 400 may auto-identify the digital display device as two separate audio devices for each audio data format as described in embodiments herein. As described in various embodiments herein, an automatic selection of the audio data format may be made based on the status of the USB pin receptacle 495 or 496 for the USB controller 461 status or the user may be prompted by the information handling system 400 to select which of these detected devices and audio data formats with which the audio data should be output. In other words, the digital display device may automatically select and identify itself as the automatically selected audio device of a particular audio data format in some embodiments when an audio profile setting is detected such that advanced user audio control is not required. In other embodiments, the user may select whether to output audio in a UAC1 audio data format with the digital display device identifying itself as a USB audio device or to output audio in a DP alternate audio format with the digital display device identifying itself as a DisplayPort® audio device (e.g., the digital display device acting as a DP audio device rather than a USB audio device).

An audio signal device prioritizing controller 462a of an information handling system 400 executing machine readable code instructions of a USB Audio Device Prioritizing system and working in tandem with a display device hardware controller of an operably coupled digital display device executing machine readable code instructions of a USB Audio Device Prioritizing agent may receive notification of the automatically-select audio data format or the user-selected audio data format and configure the reconfigurable MUX 460 via a control channel 465. The audio signal device prioritizing controller 462a may switch or maintain operable coupling between the shared receptacle pins 493 and 494 (as well as 491 and 492 in some embodiments) with the corresponding USB controller 461 or GPU 406 via the reconfigurable MUX 460 using the control channel 465 depending on the received notification from the digital display device via an EDID notification in embodiments herein. Control channel 464 may also be used to determine orientation of the USB Type-C connection within the USB Type-C port receptacle 426b for determining orientation of pins connected in some embodiments. GPU 406 may be operably coupled with the reconfigurable MUX 460 via pins 481, 482, 483, and 484 in an embodiments and may be connected to shared receptacle pins 491, 492, 493, and 494 respectively through switching (or maintaining) connection via the reconfigurable MUX 460. USB controller 461 may be operably coupled with the reconfigurable MUX 460 via pins 471, 472, 473, and 474 in an embodiments and may be connected to shared receptacle pins 491, 492, 493, and 494 respectively through switching (or maintaining) connection via the reconfigurable MUX 460. USB controller 461 may also include pin 475 connected through reconfigurable MUX 460 to USB dedicated receptacle pin 495 or 496 of the USB Type-C port receptacle 426b according to embodiments herein. In the shown embodiment, where the audio signal device prioritizing controller 462a of an information handling system 400 executing machine readable code instructions of a USB Audio Device Prioritizing system is notified that a USB audio device has been automatically or user-selected, the reconfigurable MUX 460 configures to operably couple the GPU 406 via pins 481 and 482 to shared receptacle pins 491 and 492 for video data. Further, in the selection of the USB audio device, the reconfigurable MUX 460 configures to operably couple the USB controller 461 via pins 471, 472, 473 and 474 to shared receptacle pins 491, 492, 493 and 494, with receptacle pins 493 and 494 for UAC1 audio formatted data from the USB controller 461.

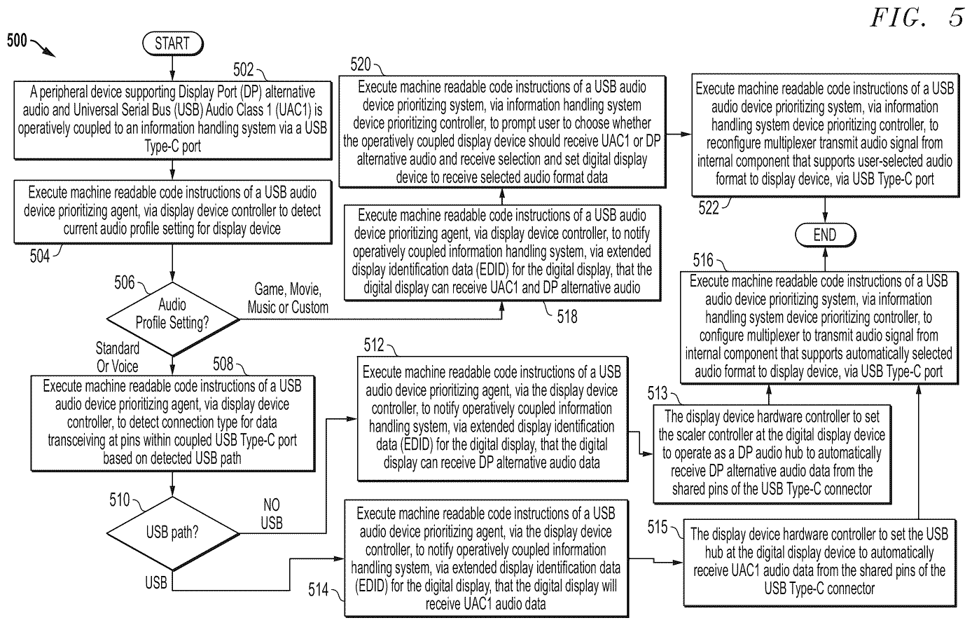

FIG. 5 is a flow diagram illustrating a method of executing machine readable code instructions of a USB Audio Device Prioritizing system and agent on an information handling system and an operably coupled digital display device respectively to work in tandem to automatically select between audio data formats for configuring shared pins on a USB Type-C connection between the information handling system and the operatively coupled digital display device according to an embodiment herein. In an embodiment, a digital display device may support two audio formats, the USB Audio Class 1 (UAC1) audio format and the DisplayPort® alternate audio format, for receiving output of audio data from the information handling system. In such as case, the digital display device may provide data indicating the audio formats supported and usage of the digital display device which, along with execution of software applications on the operatively coupled information handling system, are used to determine detected usage profile settings describing the way in which the user is currently using the digital display device according to an embodiment of the present disclosure. As described herein, when a digital display device detects a USB data path for audio by receiving audio signals via both the UAC1 audio format and the DP alternate audio format via a multi-format USB Type-C connection with shared pins, it reports via an extended display data identification (EDID) to the operably coupled information handling system its capabilities and usage. In this case, the information handling system may identify the digital display device as two separate devices since the capabilities include one device as a USB hub and another device as a DP hub. Embodiments of the present disclosure avoid prompting the user of the information handling system to select which of these detected devices to which the audio should be output which can be confusing to some users and generate complaints. The audio signal device prioritizing controller of the information handling system executes machine readable code instructions of a USB Audio Device Prioritizing system to work in tandem with the display device hardware controller executing machine readable code instructions of a USB Audio Device Prioritizing agent in embodiments herein to automatically select the audio format for output of audio to the digital display device depending on the detected usage profile settings. In other words, the information handling system may automatically select and reconfigure a MUX connecting to the shared USB Type-C connector audio pins whether to output audio to a USB device (e.g., the digital display device USB hub acting as a USB audio output device) in the UAC1 format or to output audio to a DisplayPort® device (e.g., the DP device hub at the scaler hardware controller acting as a DP device rather than a USB device) according to embodiments herein.

At block 502, a peripheral device supporting Display Port (DP) alternate audio and Universal Serial Bus (USB) Audio Class 1(UAC1 ) may be operatively coupled to an information handling system in an embodiment via a USB Type-C connection having shared audio pins capable to transmit audio data. The current USB Type-C standard supports transmission and receipt of audio signals according to multiple audio formats via these same shared pins, for example four shared pins, with audio data generated in each audio format by different components of the information handling system and requiring encoding and decoding using separate audio codecs and component hubs within the digital display device operably coupled to the information handling system via the USB Type-C port. For example, in an embodiment described herein, the USB Type-C connection includes a USB Type-C cable for use with USB Type-C connectors and ports at each end between the information handling system and the operably coupled digital display device. The USB Type-C connection includes shared pins, such as 391, 392, 393, and 394 of FIG. 3, that support transmission and/or receipt of audio signals according to the USB Audio Class 1(UAC1 ) standard, as well as according to the DisplayPort® (DP) alternate audio standard in embodiments herein. UAC1 may support bi-directional audio data such as to a speaker or from a microphone on-board the digital display device while DP alternate audio standard may support more high-fidelity single direction playback of audio data in some embodiments herein.

At block 504, in an embodiment, a user may select an audio mode as an audio profile setting for the digital display device or an audio mode may already be selected as an audio profile setting. For example, the display device hardware controller may execute machine readable code instructions of the USB Audio Device Prioritizing agent to present in an audio settings graphical user interface (GUI), selection of plural audio modes to a user. The display device hardware controller may execute machine readable code instructions of the USB Audio Device Prioritizing agent to detect a mode as an audio profile setting selected by a user in an embodiment. In other embodiments, a user may use a default mode, such as a standard or voice mode, as the audio profile setting without interfacing with the audio profile settings GUI. In some embodiments, the user initiate change to a selection of a mode while using the digital display device.

Proceeding to block 506, the display device hardware controller may execute machine readable code instructions of the USB Audio Device Prioritizing agent to determine a mode selected by a user via the GUI at the digital display device or determine that a default mode is in effect as the audio profile setting for the digital display device. When a “standard” mode or “voice” mode is detected as the audio profile setting at block 506, the method may proceed to block 508 to enable an automatic selection of the audio data format used and the switching of shared pins on the USB Type-C port via the reconfigurable MUX depending on the detected audio format to be used from the existence of an active USB audio data path on the USB Type-C connection. This automatic selection of audio device type and audio data format to be used may avoid the user having to select audio device type and audio data format when the digital display device that supports multiple audio formats via a USB Type-C connection is operably coupled to the information handling system.

As described further below, in the case where the digital display device is currently set to standard or voice audio profile and the USB pins indicate an active USB path to the USB controller on the information handling system, this may indicate that the user is participating in a videoconference or, at the least, is not using the digital display device to view video with high audio fidelity and the UAC1 audio format standard is automatically selected. In such a case, it may be beneficial to receive audio in the UAC1 audio format that supports echo cancellation, in order to provide a better user experience during a videoconference by decreasing outside noises. The display device hardware controller may execute machine readable code instructions of the USB Audio Device Prioritizing agent in such a scenario to automatically select for receipt of audio using the UAC1 standard and identify itself to the information handling system as a USB audio device using an EDID transmitted from the digital display device to the information handling system. This may automatically select for the best audio format for the current usage of the digital display device without prompting the user to make such a selection.

In another example, in the case where the digital display device is currently set to set to standard or voice audio profile and the USB pins indicate an active USB path to the USB controller on the information handling system, this may indicate that the user is using the digital display device to view video with high audio fidelity in which the higher quality DP alternate audio format may be beneficial. In such a case, it may be beneficial to receive audio in the DP alternate audio format in order to provide a better user experience during a viewing of video playback or gaming applications with higher audio fidelity. The display device hardware controller may execute machine readable code instructions of the USB Audio Device Prioritizing agent in such a scenario to automatically select for receipt of audio using the DP alternate audio format standard and identify itself to the information handling system as a DP audio device using an EDID transmitted from the digital display device to the information handling system. This may automatically select for the best audio format for the current usage of the digital display device without prompting the user to make such a selection as well.

However, if the display device hardware controller executes machine readable code instructions of the USB Audio Device Prioritizing agent detects music mode, gaming mode, video mode, or a custom mode in the selection of mode settings by a user as the audio profile setting, this indicates a desire for the user to have advanced user control. In such an embodiment, deactivation occurs of the automatic selection of the audio data format used and the automatic configuring of shared pins on the USB Type-C port via the reconfigurable MUX depending the detection of an active USB audio data path. For example, it may be determined in an embodiment at block 506 that the digital display device is currently set to a movie, gaming, music, or custom audio mode as the audio profile setting in which a user of the digital display device prefers additional control. In the embodiment where the digital display device is currently set to a movie, music, gaming, or customized audio profile setting, this may indicate that the user requires further control over use of the digital display device to view video, listen to music, or game with high audio fidelity, or conduct video or audio communications within gaming or video conferencing, or for other purposes in which having a choice between supported DP alternate audio format or UAC1 audio format may be beneficial. Flow may then proceed to block 518 to provide the user a choice between invoking DP alternate audio format with the digital display device as a DP audio device or invoking UAC1 audio format with the digital display device operating as a USB audio device.

Returning to block 508, a display device hardware controller may execute machine readable code instructions of a USB Audio Device Prioritizing agent to detect a connection type for data transceiving at each pin, and in particular for the shared pins, within the coupled USB Type-C port. For example, in embodiments described with reference to FIG. 4, the USB audio output device prioritizing agent may detect that two of the USB Type-C pins 495 and 496 of the USB Type-C receptacle or port 426b on the information handling system 400 have an active USB transmitting and receiving path indicating that the user is currently using the digital display device as a USB audio device. In such as case, the operation of the information handling system will be with audio according to the USB standard, such as the UAC1 audio standard on the shared pins 493 and 494 of the USB Type-C connection at the USB Type-C port 426b. In another example embodiment, described with reference to FIG. 3, the pin receptacle sets 395 and 396 of the USB Type-C port 326b in an embodiment on the information handling system 300 do not have an active USB transmitting and receiving path indicating that the user is currently using the digital display device as a DP audio device. Thus, the USB Type-C connection may be capable of transmission, such as via shared transmission pin 393, 493 and shared reception pin via 394, 494 of audio signals from various internal hardware components of the information handling system 300, 400 according to either the DP alternate audio format or the UAC1 audio format.

At block 510, the connection for audio data format type transceiving at one or more shared pins within the coupled USB Type-C port may be determined, for example based on detection of the active USB path or not. Each of the available audio data formats supported by the USB Type-C standard provide different benefits over one another. For example, the DP alternate audio standard was developed to provide higher quality or higher fidelity audio than the existing USB audio standards, but may be used, in some embodiments, with single direction streaming audio and which may be preferable to a user that is watching a movie, listening to music, or playing a computer game in which high fidelity is valued. However, the UAC1 audio format supports echo cancellation and two-way audio data communications which may be beneficial to a user participating in a videoconference in which many participants may be talking over one another or simultaneously. In still other situations, some digital display devices or USB Type-C cables may only be capable of supporting one of these audio formats. The display device hardware controller may execute machine readable code instructions of the USB Audio Device Prioritizing agent in embodiments herein to detect which of these audio formats are supported by the digital display device, as well as the current availability of an active USB path on the USB Type-C connector pins. Then the display device hardware controller execute machine readable code instructions of the USB Audio Device Prioritizing agent automatically prompt the information handling system to switch or maintain a reconfigurable MUX to the USB Type-C connector to transmit audio data according to the audio format automatically selected as most beneficial for the detected usage type based on activity on the USB dedicated pins in the USB Type-C connector.

For example, if the USB Type-C port is transceiving audio data in DP alternate audio format based on the detection of no active USB path, the method may proceed to block 512 to notify the information handling system to recognize the digital display device as a DP audio output device and to automatically transmit audio data according to the DP alternate audio format. If the USB Type-C port is transceiving audio data in UAC1 format based on detection of an active USB path, the method may proceed to block 514 to notify the information handling system to recognize the digital display device as a USB audio output device and to automatically transmit audio data according to the UAC1 format.

In an embodiment at block 512 in which the USB Type-C port is set to transceive audio data in DP alternate audio format, the display device hardware controller may execute machine readable code instructions of a USB Audio Device Prioritizing agent at the digital display device to notify the operatively coupled information handling system, via extended display identification data (EDID) for the digital display device, that the digital display device can receive DP alternate audio and should be recognized as a DP audio device. In one embodiment, the display device hardware controller may execute machine readable code instructions of the USB audio output device prioritizing agent to detect that USB data path of the USB Type-C connection is not active indicating no USB audio is used and then generate a report to the information handling system to set the reconfigurable MUX and its USB Type-C port to transmit audio data via the DP alternate audio standard on shared pins of the USB Type-C connection. As another example, the display device hardware controller may execute machine readable code instructions of the USB audio output device prioritizing agent to detect that two of the USB Type-C pins of the USB Type-C connector are active for transmitting and receiving audio according to the DP alternate audio standard, indicating that the user is currently using the digital display device as a display device, rather than a USB audio output device. In such scenarios, the display device hardware controller may execute machine readable code instructions of the USB Audio Device Prioritizing agent to identify itself to the information handling system, upon connection to the information handling system, as a digital display device including a DP audio device using the extended display identifier (EDID) transmitted from the digital display device to the information handling system.

At block 513, the display device hardware controller at the digital display device may then set the scaler controller on the digital display device to operate as a DP audio hub and automatically receive audio data in the DP alternate audio format on the shared pins of the USB Type-C connection from the operatively coupled information handling system in embodiments herein.

The method may then proceed to block 516 for automatic transmission of an audio data signal from the corresponding component of the information handling system to the digital display device on the shared pins of the USB Type-C connector in the automatically selected audio format, such as the DP alternate audio format automatically selected by the display device hardware controller at block 513. For example, information handling system may be notified of the digital display device operating as a DP audio device and transmit audio data via the reconfigurable MUX on the shared pins of the USB Type-C port in the DP alternate audio format from the GPU on the information handling system. In such an embodiment, the GPU of the information handling system is capable and generates the audio data in the DP alternate format for playback at the operatively coupled information handling system. At this point the method may end.

Returning to block 510, in which the display device hardware controller executing machine readable code instructions of a USB Audio Device Prioritizing agent detects the USB data path on USB pins at the USB Type-C port in an embodiment, this indicates the user and information handling system is set to transceive audio data in UAC1 format. Proceeding to block 514, the display device hardware controller executes the USB Audio Device Prioritizing agent to notify the operatively coupled information handling system operating system, via EDID for the digital display, that the digital display can receive audio in the UAC1 audio format and should be recognized as a USB audio device. In another example embodiment, the display device hardware controller may execute machine readable code instructions of the USB Audio Device Prioritizing agent to detect that at least two of the shared USB Type-C pins are set up for transmitting and receiving audio according to the UAC1 standard, indicating that the user is currently using the digital display device as a USB audio output device, or that the USB Type-C cord, port, or connector does not support the DP alternate audio standard, as may be the case with older components. In such scenarios, the display device hardware controller may execute machine readable code instructions of the USB Audio Device Prioritizing agent to identify itself to the information handling system, upon connection to the information handling system, as a digital display device including a USB audio device using the extended display identifier (EDID) transmitted from the digital display device to the information handling system.

At block 515, the display device hardware controller at the digital display device may then set the USB hub on the digital display device to automatically receive audio data in the USB audio format, such as UAC1 or USB 2.0 on the shared pins of the USB Type-C connection from the operatively coupled information handling system in embodiments herein.

The method may then proceed to block 516, similar to before, for automatic transmission of an audio data signal from the corresponding component of the information handling system to the digital display device on the shared pins of the USB Type-C connector in the automatically selected audio format, such as the UAC1 audio format automatically selected by the display device hardware controller at block 514. For example, information handling system may be notified of the digital display device operating as a USB audio device and transmit audio data via the reconfigurable MUX on the shared pins of the USB Type-C port in the UAC1 audio format from the USB controller on the information handling system. In such an embodiment, the USB controller of the information handling system is capable and generates the audio data in the UAC1 format for playback or exchange of audio data at the operatively coupled information handling system. At this point the method may end.

In an embodiment at block 514, an information handling system device prioritizing controller may execute machine readable code instructions of a USB Audio Device Prioritizing system at the information handling system to switch or maintain the reconfigurable MUX at the USB Type-C connector therein to connect the shared pins to transmit an audio signal to the digital display device from an internal component that supports the audio format automatically selected at blocks 512 or block 514 to configure the shared pins of the USB Type-C port. For example, once an audio format has been automatically selected by the display device hardware controller executing machine readable code instructions of the USB Audio Device Prioritizing agent at block 512 or 514, an audio signal device prioritizing controller of the information handling system executing machine readable code instructions of a USB Audio Device Prioritizing system may use a control channel to the reconfigurable MUX to switch or maintain the MUX connections to operably connect a hardware component that supports the selected audio format to the shared pins of the USB Type-C port of the information handling system. For example, the audio signal device prioritizing controller of the information handling system executing machine readable code instructions of the USB Audio Device Prioritizing system may operably connect a USB controller that supports the selected UAC1 format to the shared pins of the USB Type-C port of the information handling system via the reconfigurable MUX. As another example, the audio signal device prioritizing controller of the information handling system executing machine readable code instructions of the USB Audio Device Prioritizing system may operably connect a graphics processing unit that supports the selected DP alternate audio format to the shared pins of the USB Type-C port of the information handling system via the reconfigurable MUX.

In such a way, the audio signal device prioritizing controller of the information handling system executing machine readable code instructions of a USB Audio Device Prioritizing system may work in tandem with a display device hardware controller of an operably coupled digital display device executing machine readable code instructions of a USB Audio Device Prioritizing agent in embodiments of the present disclosure to automatically select between the UAC1 audio format and the DP alternate audio format for output of audio data to the newly connected digital display device. In embodiments, automatic selection between the audio formats depends on the detected audio profile setting. The automatic selection between audio formats is determined by the digital display device capabilities and detection of an active USB data path on USB-dedicated pins of the USB Type-C connector operatively coupling the digital display device to the information handling system. In this way, the newly connected digital display device may avoid prompting the user with making a selection in some embodiments, where advanced selection is not necessary or warranted. This increases the automation of set up of the digital display device and leads to improving user satisfaction for some users while providing flexibility of advanced control for others. The method for automatically selecting between the UAC1 audio format and the DP alternate audio format for output of audio to the digital display device, depending on the current audio profiled setting may then end.

Returning to block 506, where the digital display device is currently set to a movie, music, gaming, or customized audio profile setting, this may indicate that the user requires further control over use of the digital display device to view video, flow proceeds to block 518. At block 518, the display device hardware controller may execute machine readable code instructions of the USB Audio Device Prioritizing agent to detect that the current audio profile setting for the digital display device requires advanced user control and indicate, via EDID to the OS of the operatively coupled information handling system, that the digital display device is capable and available as both a USB audio device and a DP audio device. As described herein, this may cause the information handling system to recognize the digital display device as two separate audio devices and prompt the user to choose which device to which audio should be output. In such an embodiment, the display device hardware controller may prompt the user a choice for selection between the UAC1 format and the DP alternate audio format for the digital display device to be able to operate as either available audio device. A audio device selection GUI may be presented to the user upon connection, when the audio profile setting is not a “standard” mode or “voice” mode, identifying the digital display device as either a USB audio device or as a DP audio device and allowing the user to manually select an option that is best for the user's application or purposes. The display device hardware controller may execute machine readable code instructions of the USB Audio Device Prioritizing agent to transmit single EDID identifying both audio formats to identify identifying the digital display device as supporting both audio formats, and allowing the user to choose a preference. In such an embodiment, the display device hardware controller notifies the OS of the information handling system, via the EDID, to recognize the digital display device as both a USB audio output device and a display audio device and to allow the user to select which audio mode is preferred.

Proceeding to block 520, the display device hardware controller may execute machine readable code instructions of the USB Audio Device Prioritizing agent in such a scenario to prompt the user to make a selection between the UAC1 format and the DP alternate audio format as additional dual audio control. The display device hardware controller may automatically generate the audio device selection GUI or notice to the user of a selection required between the UAC1 format for USB audio device operation at the digital display device or for DP alternate audio format for operation of the DP audio device at the digital display device.

The information handling system device prioritizing controller in an embodiment at block 520 may execute machine readable code instructions of the USB Audio Device Prioritizing system to prompt the information handling system user to choose whether the operatively coupled display device should receive UAC1 or DP alternate audio. The display device hardware controller may then execute machine readable code instructions of the USB Audio Device Prioritizing agent to receive the selection from the user of either the UAC1 format or the DP alternate audio format, such as via selection in the audio device selection.

Thus, the selection of the audio data format by the user at block 520 causes the display device hardware controller to execute machine readable code instructions of a USB Audio Device Prioritizing agent at the digital display device to notify the operatively coupled information handling system, via extended display identification data (EDID) for the digital display device, that the digital display device will receive the selected DP alternate audio and should be recognized as a DP audio device or will receive the selected UAC1 audio and should be recognized as a USB audio device. In an embodiment, the display device hardware controller may execute machine readable code instructions of the USB audio output device prioritizing agent to identify the user's selection and then generate a report to the information handling system to set the reconfigurable MUX and its USB Type-C port to transmit audio data according to the selection by the user of the DP alternate audio standard or the UAC1 standard on the shared pins of the USB Type-C connection. Further, at block 520, the display device hardware controller at the digital display device may then set the scaler controller on the digital display device to operate as a DP audio hub pursuant to the user selecting the DP audio device or set the USB hub to operate as a USB audio device pursuant to the user's selection to automatically receive audio data in the corresponding selected audio format on the shared pins of the USB Type-C connection from the operatively coupled information handling system in embodiments herein.

At block 522, in an embodiment, the information handling system device prioritizing controller may execute machine readable code instructions of the USB Audio Device Prioritizing system to use a command channel to reconfigure or maintain the reconfigurable MUX to connect the component, such as the GPU for DP audio data or the USB controller for USB audio data, to the shared pins of the USB Type-C receptacle or port at the information handling system. Once reconfigured, the information handling system may then transmit an audio signal from an internal component that supports the user-selected audio format to the digital display device, via the shared pins on the USB Type-C port. At this point, the method may end.

The blocks of the flow diagram of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A digital display device operating a universal serial bus (USB) audio device prioritizing agent comprising:
a display panel, an audio speaker device, and a power source;
a display device controller to execute machine readable code instructions of the USB audio device prioritizing agent to detect an initial audio profile setting for the digital display device that is configured for automatic audio data format selection;
the display device controller to execute machine readable code instructions to transmit to an information handling system, via a USB Type-C connector that operatively couples the digital display device to a USB Type-C port of the information handling system, an initial extended display identification data (EDID) that identifies the digital display device as a USB audio device compatible with a USB audio data format standard if the display device controller detects that a USB data path is active at least at a USB dedicated pin within a USB Type-C connector operatively coupling the digital display device with an information handling system; and
a USB hub at the digital display device to automatically receive an audio data signal in the USB audio data format standard from the information handling system via shared pins of the USB Type-C connector.

2. The digital display device of claim 1 further comprising:
the display device controller to execute machine readable code instructions to transmit the initial extended display identification data (EDID) that identifies the digital display device as a DisplayPort® (DP) audio device compatible with a DP audio data format standard if the display device controller detects that the USB data path is inactive at the USB dedicated pin within the USB Type-C connector.

3. The digital display device of claim 2 further comprising:
a scaler hardware controller operating as a DP hub at the digital display device to automatically receive an audio data signal in the DP audio data format standard from the information handling system via shared pins of the USB Type-C connector when the digital display device is identified as the DP audio device; and
the display device controller to execute machine readable code instructions of a DP audio codec module for processing the audio data signal received in the DP audio data format standard.

4. The digital display device of claim 1 further comprising:
the display device controller to execute machine readable code instructions to route the received audio signal in the USB audio data format standard from the shared pins of the USB Type-C connector to a USB hub; and
the display device controller to execute machine readable code instructions of a USB audio codec module for processing the audio data signal received in the USB audio data format standard.

5. The digital display device of claim 1, wherein the USB audio data format standard is a USB audio class 1 (UAC1) audio data format.

6. The digital display device of claim 1, wherein the DP audio data format standard is a DP alternate audio data format.

7. The digital display device of claim 1 further comprising:
the display device controller to execute machine readable code instructions to detect the audio profile setting for the digital display device is not configured for automatic audio format selection;
the display device controller to execute machine readable code instructions to display an audio data format selection graphical user interface on the display panel to prompt a user to select between the digital display device as the USB audio device supporting the USB audio data format standard and the digital display device as a DP audio device supporting the DP audio data format standard; and
the display device controller to receive a user's selection of the digital display device as the USB audio device or the digital display device as the DP audio device;
the digital display device transmitting the initial EDID notification to the information handling system via the USB Type-C connector to identify the digital display device as compatible to receive audio data with the USB audio data format standard or the DP audio data format standard corresponding to the user's selection in the initial EDID notification.

8. A method of executing machine readable code instructions to automatically prioritize Universal Serial Bus (USB) audio device designation of a digital display device operatively coupled to an information handling system comprising:
detecting an initial audio profile setting, via a display device controller executing machine readable code instructions, of a USB audio device prioritizing agent at the digital display device, where the audio profile setting is configured for automatic audio data format selection;
transmitting to the information handling system, via a USB Type-C connector that operatively couples the digital display device to a USB Type-C port of the information handling system, an initial extended display identification data (EDID) notification that identifies the digital display device as a USB audio device compatible with a USB audio class 1(UAC1 ) audio data format standard if the display device controller detects that a USB data path to a USB controller at the information handling system is active at least at a USB dedicated pin within the USB Type-C connector; and
automatically receiving an audio data signal in the UAC1 audio data format standard from the information handling system via shared pins of the USB Type-C connector; and
playing the audio data on an audio speaker device at the digital display device.

9. The method of claim 8 further comprising:
detecting, at the display device controller, that the USB data path is inactive at the USB dedicated pin within the USB Type-C connector;
transmitting the initial EDID notification that identifies the digital display device as a DisplayPort® (DP) audio device compatible with a DP alternate audio data format standard; and
automatically receiving an audio data signal in the DP alternate audio data format standard from the information handling system via shared pins of the USB Type-C connector.

10. The method of claim 9 further comprising:
routing, via the display device controller executing machine readable code instructions, the received audio data signal in the DP alternate audio standard to a scaler hardware controller operating as a DP hub and to a DP audio codec module for processing the received audio data signal in the DP alternate audio data format standard.

11. The method of claim 8 further comprising:
routing, via the display device controller executing machine readable code instructions, the received audio signal in the UAC1 audio data format standard to a USB hub and to a USB audio codec for processing the received audio signal data in the UAC1 audio data standard.

12. The method of claim 8 further comprising:
detecting, via the display device controller, that the audio profile setting for the digital display device is not configured for automatic audio format selection; and
displaying an audio data format selection graphical user interface on the display panel to prompt a user to select between the digital display device as the USB audio device supporting the UAC1 audio data format standard and the digital display device as a DP audio device supporting the DP alternate audio data format standard.

13. The method of claim 8 further comprising:
detecting, via the display device controller, that the audio profile setting for the digital display device is not configured for automatic audio format selection;
receiving a user's selection of the digital display device as the USB audio device or the digital display device as the DP audio device; and
transmitting the initial EDID notification to the information handling system via the USB Type-C connector to identify the digital display device as compatible to receive audio data with the USB audio data format standard or the DP audio data format standard corresponding to the user's selection in the initial EDID notification received.

14. The method of claim 8 further comprising:
detecting, via the display device controller executing machine readable code instructions, an updated audio profile setting for the digital display device that is not configured for automatic audio format selection;
receiving a user's selection of the digital display device as the USB audio device or the digital display device as the DP audio device; and
transmitting an updated EDID notification to the information handling system via the USB Type-C connector to identify the digital display device as compatible to receive audio data with the USB audio data format standard or the DP audio data format standard corresponding to the user's selection in the updated EDID notification received.

15. A digital display device operating a universal serial bus (USB) audio device prioritizing agent comprising:
a display panel, an audio speaker device, and a power source;
a display device controller to execute machine readable code instructions of the USB audio device prioritizing agent to detect an initial audio profile setting for the digital display device that is configured for automatic audio data format selection;
the display device controller to execute machine readable code instructions to transmit to an information handling system, via a USB Type-C connector that operatively couples the digital display device to a USB Type-C port of the information handling system, an initial extended display identification data (EDID) that identifies the digital display device as a USB audio device compatible with a USB audio data format standard if the display device controller detects that a USB data path is active at least at a USB dedicated pin within the USB Type-C connector;
a USB hub at the digital display device to automatically receive an audio data signal in the USB audio data format standard from the information handling system via shared pins of the USB Type-C connector when the digital display device is identified as the USB audio device;
the display device controller to execute machine readable code instructions to transmit to an information handling system, via the USB Type-C connector, the initial extended display identification data (EDID) that identifies the digital display device as a DisplayPort® (DP) audio device compatible with a DP audio data format standard if the display device controller detects that the USB data path is inactive at the USB dedicated pin within the USB Type-C connector; and
a scaler hardware controller operating as a DP hub at the digital display device to automatically receive an audio data signal in the DP audio data format standard from the information handling system via shared pins of the USB Type-C connector when the digital display device is identified as the DP audio device.

16. The digital display device of claim 15 further comprising:
the audio speaker device at the digital display device playing the audio data automatically received from the information handling system via the shared pins of the USB Type-C connector.

17. The digital display device of claim 15 further comprising:
the display device controller to execute machine readable code instructions to detect the audio profile setting for the digital display device is not configured for automatic audio format selection and to display an audio data format selection graphical user interface on the display panel to prompt a user to select between the digital display device as the USB audio device supporting the USB audio data format standard and the digital display device as a DP audio device supporting the DP audio data format standard.

18. The digital display device of claim 17 further comprising:
the display device controller to receive a user's selection of the digital display device as the USB audio device or the digital display device as the DP audio device and transmit the initial EDID notification to the information handling system via the USB Type-C connector to identify the digital display device as compatible to receive audio data with the USB audio data format standard or the DP audio data format standard corresponding to the user's selection in the initial EDID notification received.

19. The digital display device of claim 15, wherein the USB audio data format standard is a USB audio class 1 (UAC1) audio data format.

20. The digital display device of claim 15, wherein the DP audio data format standard is a DP alternate audio data format.
